(19) United States
(12) Patent Application Publication
(10) Pub. No.: US 2016/0011468 A1
(43) Pub. Date: Jan. 14, 2016

(54) LIQUID CRYSTAL DISPLAY DEVICE

(71) Applicant: Samsung Display Co., Ltd., Yongin-city (KR)

(72) Inventors: Se Hyun LEE, Seoul (KR); Jae-Soo Jang, Suwon-si (KR); Ho Kil Oh, Yongin-si (KR); Hyo Ju Jung, Incheon (KR); Ki Chul Shin, Seongnam-si (KR)

(21) Appl. No.: 14/551,795

(22) Filed: Nov. 24, 2014

(30) Foreign Application Priority Data
Jul. 9, 2014 (KR) 10-2014-0086237

(51) Int. Cl. G02F 1/1343; G02F 1/1333; G02F 1/1362

(52) U.S. Cl. CPC G02F 1/134309; G02F 1/136286; G02F 1/133345; G02F 2001/134345

(57) ABSTRACT

A liquid crystal display including: a substrate; an insulating layer formed on the substrate; a step providing grooves formed on the insulating layer; and a pixel electrode formed on the insulating layer, and configured to include a partial plate electrode and a plurality of minute branch electrodes extending from the partial plate electrode. A sidewall of each of the step providing grooves is perpendicular to a bottom surface, and a planar shape of the step providing grooves is formed of right triangles each having a first side, a second side, and a hypotenuse that connects the first side with the second side, and an angle between the first side and the hypotenuse is 45° or below.

### CROSS-REFERENCE TO RELATED APPLICATION

This application claims priority from and the benefit of Korean Patent Application No. 10-2014-0086237 filed on Jul. 9, 2014, which is hereby incorporated by reference for all purposes as if fully set forth herein.

### BACKGROUND

1. Field

Exemplary embodiments relate to a liquid crystal display (LCD), and more particularly, to a liquid crystal display for reducing texture and improving side visibility.

2. Discussion of the Background

A liquid crystal display, which is one of the most common types of flat panel displays currently in use, includes two sheets of display panels with field generating electrodes such as a pixel electrode, a common electrode, and the like, and a liquid crystal (LC) layer interposed therebetween. In the liquid crystal layer, voltages are applied to the field generating electrodes to generate an electric field in the liquid crystal layer. Then, the alignment of liquid crystal molecules of the liquid crystal layer is determined by the electric field to control the polarization of incident light, thereby displaying images.

LCDs include a vertical alignment (VA) mode LCD, which aligns LC molecules such that their long axes are perpendicular to the panels in the absence of an electric field.

In the vertical alignment (VA) mode LCD, a wide viewing angle may be realized by cutouts such as minute slits in the field-generating electrodes. Since the cutouts and protrusions may determine the tilt directions of the LC molecules, the tilt directions may be distributed in various directions by using the cutouts and protrusions such that the reference viewing angle is widened.

When forming the minute slits in the pixel electrode to form branch electrodes are formed, an aperture ratio of the liquid crystal display may be reduced. Thus, the transmittance of the LCD may also deteriorate.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide a liquid crystal display that has increased transmittance and an aperture ratio, which may reduce texture, and improve side visibility.

Additional aspects will be set forth in the detailed description which follows, and, in part, will be apparent from the disclosure, or may be learned by practice of the inventive concept.

An exemplary embodiment of the present invention provides a liquid crystal display including: a substrate; an insulating layer disposed on the substrate; step providing grooves disposed on the insulating layer; and a pixel electrode disposed on the insulating layer, the pixel electrode including a partial plate electrode and minute branch electrodes extending from the partial plate electrode, in which a sidewall of each of the step providing grooves is perpendicular to a bottom surface thereof, a planar shape of the step providing grooves includes right triangles each of has a first side, a second side, and a hypotenuse that connects the first side and the second side, and an angle between the first side and the hypotenuse is less than or equal to 45°.

The planar shape of the step providing grooves may include four right triangles, the triangles may be disposed such that first sides thereof are adjacent to each other and second sides thereof are adjacent to each other, the first sides may be disposed in a horizontal direction, and the second sides are disposed in a vertical direction.

The partial plate electrode may have a rhombus shape, and four sides of the partial plate electrode may be respectively parallel to the hypotenuses of the four right triangles.

The liquid crystal display may further include a gate line disposed on the substrate and extending in a direction that is parallel to the first sides of the step providing grooves, in which an angle between one side of the partial plate electrode and the gate line may be less than or equal to 45°.

Another exemplary embodiment of the present invention provides a liquid crystal display including: a substrate; an insulating layer disposed on the substrate; a step providing grooves disposed on the insulating layer; and a pixel electrode formed on the insulating layer, the pixel electrode including a partial plate electrode and minute branch electrodes extending from the partial plate electrode, in which a sidewall of each of the step providing grooves is inclined, and a planar shape of the step providing grooves includes right triangles each of which has a first side, a second side, and a hypotenuse that connects the first side and the second side, and an angle between the first side and the hypotenuse is in a range from 45° to 63°.

The sidewall of each of the step providing grooves may be inclined with respect to a bottom surface thereof.

The partial plate electrode disposed on the inclined sidewall of each of the step providing grooves may be inclined.

The sidewall of each of the step providing grooves may be integrally formed to be inclined with respect to a bottom surface thereof.

The planar shape of the step providing grooves may include four right triangles, the triangles may be disposed such that the first sides thereof are adjacent to each other and the second sides thereof are adjacent to each other, and the first sides may be disposed in a horizontal direction, and the second sides may be disposed in a vertical direction.

The partial plate electrode may have a rhombus shape, and four sides of the partial plate electrode may be respectively parallel to the hypotenuses of the four right triangles.

The liquid crystal display may further include a gate line formed on the substrate in a direction that is parallel to the first sides of the step providing grooves, and an angle between one side of the partial plate electrode and the gate line may be in a range from 45° to 63°.

According to the exemplary embodiments of the present invention, the liquid crystal display has the following effects.

The liquid crystal display according to the exemplary embodiments of the present invention can increase transmittance and an aperture ratio, reduce texture, and improve side visibility.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a layout view of a liquid crystal display according to an exemplary embodiment of the present invention.

FIG. 2 is a cross-sectional view taken along the line II-II of FIG. 1.

FIG. 3 is a view illustrating a liquid crystal display according to an exemplary embodiment of the present invention.

FIG. 4 is a gray-transmittance graph illustrating a front surface and a side surface of a liquid crystal display according to an exemplary embodiment of the present invention.

FIG. 5 is a layout view of a liquid crystal display according to an exemplary embodiment of the present invention.

FIG. 6 is a cross-sectional view taken along the line VI-VI of FIG. 5.

FIG. 7 and FIG. 8 are views illustrating a liquid crystal display according to an exemplary embodiment of the present invention.

FIG. 9 and FIG. 10 are gray-transmittance graphs illustrating a front surface and a side surface of a liquid crystal display according to an exemplary embodiment of the present invention.

FIG. 11 is a layout view of a liquid crystal display according to an exemplary embodiment of the present invention.

FIG. 12 is a cross-sectional view taken along the line XII-XII of FIG. 11.

FIG. 13 and FIG. 14 are views illustrating a liquid crystal display according to an exemplary embodiment of the present invention.

FIG. 15 and FIG. 16 are gray-transmittance graphs illustrating a front surface and a side surface of a liquid crystal display according to an exemplary embodiment of the present invention.

FIG. 17 is a view schematically illustrating process for providing a pretilt to liquid crystal molecules by using prepolymers that are polymerized by light, such as ultraviolet rays.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

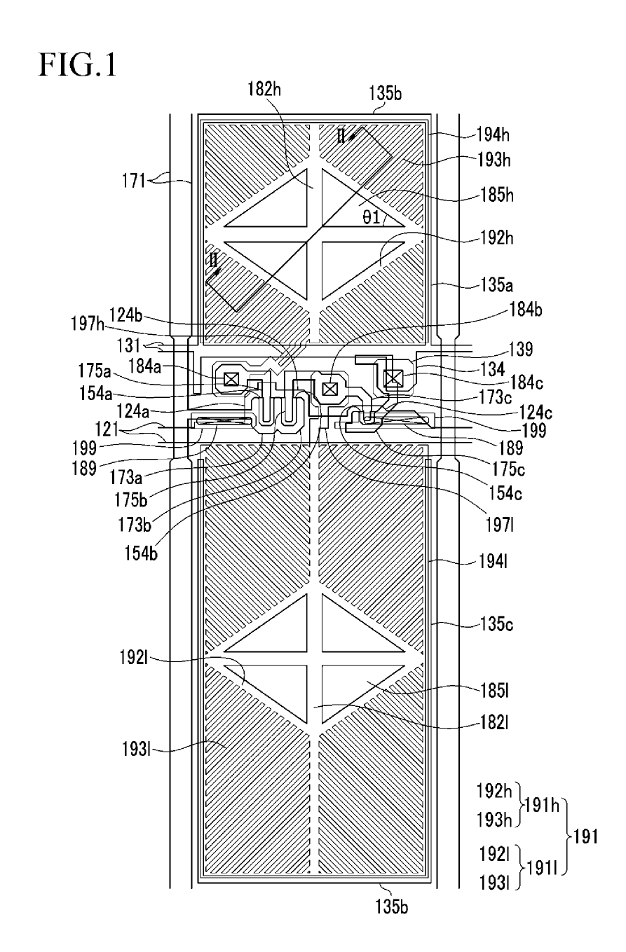

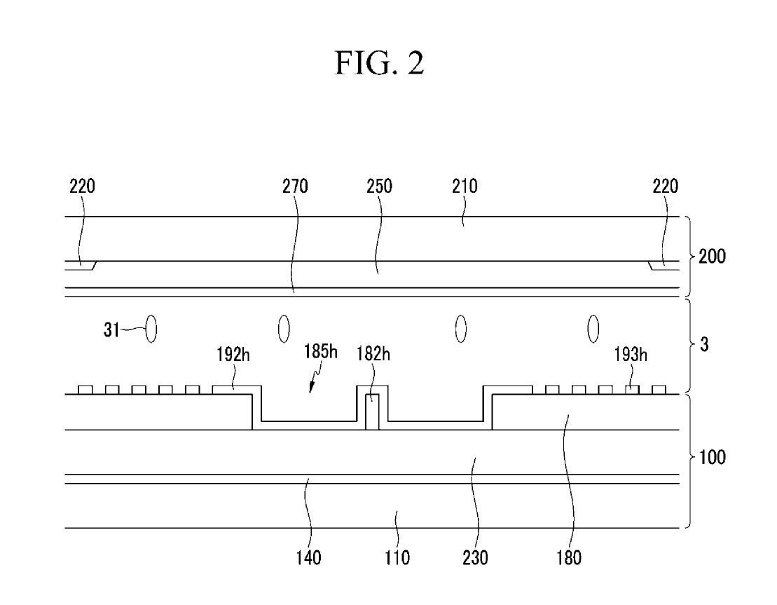

First, a liquid crystal display according to an exemplary embodiment of the present invention will be described with reference to FIG. 1 and FIG. 2.

FIG. 1 is a layout view of a liquid crystal display according to an exemplary embodiment of the present invention, and FIG. 2 is a cross-sectional view taken along the line II-II of FIG. 1.

Referring to FIG. 1, the liquid crystal display according to the exemplary embodiment of the present invention may include a pixel electrode 191 including a first sub-pixel electrode 191h and a second sub-pixel electrode 191l. The first sub-pixel electrode 191h and the second sub-pixel electrode 191l respectively include partial plate electrodes 192h and 192l positioned at a center thereof, and a plurality of minute branch electrodes 193h and 193l protruded from the partial plate electrodes 192h and 192l in an oblique direction.

Referring to FIG. 2, the liquid crystal display according to the present exemplary embodiment includes a lower display panel 100 and an upper display panel 200 disposed to face each other, a liquid crystal layer 3 interposed between the two display panels 100 and 200, and a pair of polarizers (not illustrated) attached to outer surfaces of the display panels 100 and 200. The pixel electrode 191 is formed on the passivation layer 180.

First, the lower display panel 100 will be described.

A gate line 121 and a storage voltage line 131 are formed on an insulating substrate 110. The gate line 121 and storage voltage line 131 are formed to extend in the same direction. For example, the gate line 121 and storage voltage line 131 may be formed to extend in a horizontal direction. The gate line 121 includes a first gate electrode 124a, a second gate electrode 124b, and a third gate electrode 124c. The storage voltage line 131 includes storage electrodes 135a, 135b, and 135c, and a capacitor electrode 134 that extends downward. The storage voltage line 131 includes two first longitudinal storage electrode parts 135a extending upward, a horizontal storage electrode part 135b connecting the two first longitudinal storage electrode parts 135a, and two second longitudinal storage electrode parts 135c further extending upward from the horizontal storage electrode part 135b.

The first longitudinal storage electrode part 135a is formed along a longitudinal edge of the first sub-pixel electrode 191h, and the second longitudinal storage electrode part 135c is formed along a longitudinal edge of the second sub-pixel electrode 191l. The horizontal storage electrode part 135b is positioned between a horizontal edge of a second sub-pixel electrode 191l of a previous stage and the horizontal edge of the first sub-pixel electrode 191h of the present stage, and is formed along the two horizontal edges.

As a result, the first longitudinal storage electrode part 135a and the horizontal storage electrode part 135b are formed along the edge of the first sub-pixel electrode 191h, thereby at least partially overlapping the first sub-pixel electrode 191h, and the second longitudinal storage electrode part 135c and the horizontal storage electrode part 135b are formed along the edge of the second sub-pixel electrode 191l, thereby at least partially overlapping the second sub-pixel electrode 191l.

In FIG. 1, it is illustrated as if the overlying horizontal storage electrode part 135b in the first sub-pixel electrode 191h and the underlying horizontal storage electrode part 135b in the second sub-pixel electrode 191l are separated from each other, but in actuality, horizontal storage electrode parts 135b are electrically connected to the horizontal storage electrode parts 135b of adjacent pixels PX.

A gate insulating layer 140 is formed on the gate line 121 and the storage voltage line 131. A first semiconductor 154a, a second semiconductor 154b, and a third semiconductor 154c are formed on the gate insulating layer 140.

A plurality of ohmic contacts (not shown) is formed on the first semiconductor 154a, the second semiconductor 154b, and the third semiconductor 154c.

Data conductors, including data lines 171 (including a first source electrode 173a and a second source electrode 173b), a third source electrode 173c, a first drain electrode 175a, a second drain electrode 175b, and a third drain electrode 175c are formed on the semiconductors (the first semiconductor 154a, the second semiconductor 154b, and the third semiconductor 154c), the ohmic contacts, and the gate insulating layer 140. The data line 171 may be formed to extend in a particular direction. For example, the data line 171 may be formed to extend in a longitudinal direction.

The first gate electrode 124a, the first source electrode 173a, and the first drain electrode 175a form a first thin film transistor Qa together with the first semiconductor 154a, and a channel of the first thin film transistor Qa is formed in the semiconductor 154a between the first source electrode 173a and the first drain electrode 175a. Similarly, the second gate electrode 124b, the second source electrode 173b, and the second drain electrode 175b form a second thin film transistor Qb together with the second semiconductor 154b, and a channel of the second thin film transistor Qb is formed in the semiconductor portion 154b between the second source electrode 173b and the second drain electrode 175b, while the third gate electrode 124c, the third source electrode 173c, and the third drain electrode 175c form a third thin film transistor Qc together with the third semiconductor 154c, and a channel of the third thin film transistor Qc is formed in the semiconductor 154c between the third source electrode 173c and the third drain electrode 175c.

A color filter 230 and a passivation layer 180 are sequentially formed on the gate insulating layer 140, the data conductors (171, 173c, 175a, 175b, and 175c), and exposed portions of the semiconductors 154a, 154b, and 154c. The color filter 230 may display one of three primary colors such as red, green, and blue. However, it is not limited thereto, and may display one of cyan, magenta, yellow, and white-based colors. The passivation layer 180 may be formed of an inorganic insulator such as a silicon nitride and a silicon oxide, or an organic insulator, and in the exemplary embodiment of FIG. 1, the organic insulating layer including the organic insulator is further described.

A step provider providing a step to an overlying layer is formed in the passivation layer 180 of the organic insulator. As shown in FIG. 1, step providing grooves 185h and 185l and protrusions 182h and 182l of a cross type positioned between the step providing grooves 185h and 185l are the step provider. The step providing grooves 185h and 185l include a first step providing groove 185h and a second step providing groove 185l, and the protrusions 182h and 182l include a first protrusion 182h and a second protrusion 182l. As shown in FIG. 1, a planar shape of the step providing grooves 185h and 185l is formed to have a right triangular structure including four right triangles which are formed to be symmetrical to each other in a diagonal direction. As a result, the passivation layer 180 includes the protrusions 182h and 182l of the cross type.

Specifically, the planar shape of the step providing grooves 185h and 185l is formed of four right triangles each of which has a first side that is in parallel with a gate line, a second side that is in parallel with a data line, and a hypotenuse that connects the first side with the second side. Since the gate line extends in the horizontal direction, the first side thereof is disposed in the horizontal direction. Similarly, since the data line extends in the longitudinal direction, the second side is disposed in the longitudinal direction. As a result, the four right triangles are disposed such that the first sides thereof are adjacent to each other and the second sides thereof are adjacent to each other. For example, the second sides of the horizontally adjacent right triangles may be adjacent to each other, and the first sides of the vertically adjacent triangles may be adjacent to each other.

An angle θ1 between the first side and the hypotenuse may range from about 27° to about 45°. For example, the angle θ1 between the first side and the hypotenuse may be about 35°. The liquid crystal controllability and the side visibility may be improved by adjusting the angle θ1 between the first side and the hypotenuse to be 45° or below, rather than above 45°.

In the case of the step providing grooves 185h and 185l, a sidewall is perpendicular to a bottom surface. That is, no inclination is formed on the sidewall.

In addition, the color filter 230 and the passivation layer 180 include a first contact hole 184a, a second contact hole 184b, and a third contact hole 184c respectively exposing the first drain electrode 175a, the second drain electrode 175b, and the third drain electrode 175c. The passivation layer 180 includes an opening 189 for collecting gas emitted from the color filter 230. As shown in FIG. 1, one pixel may include a pair of openings 189.

The first sub-pixel electrode 191h includes the first partial plate electrode 192h positioned at the center of a square region and the first minute branch electrodes 193h extending from the first partial plate electrode 192h, and is connected to a wide end portion of the first drain electrode 175a by a first connection 197h that extends from the square region.

The first partial plate electrode 192h has a rhombus shape, a center thereof is positioned at a center of the square region, and some vertexes of the rhombus shape meets the boundary of the square region. The first partial plate electrode 192h is disposed to surround the first step providing grooves 185h. The first partial plate electrode 192h includes four sides that are respectively in parallel with the hypotenuses of the four first step providing grooves 185h. Accordingly, an angle between one side of the first partial plate electrode 192h and the gate line may be about 45° or less.

Referring to FIG. 2, the first partial plate electrode 192h is disposed to cover the first step providing groove 185h of the passivation layer 180 and the first protrusion 182h of the cross type. As a result, the first partial plate electrode 192h has a step provided by the first step providing groove 185h of the passivation layer 180 and the first protrusion 182h of the cross type. Here, the first protrusion 182h of the cross type provides a pretilt to liquid crystal molecules 31 positioned at the center of the square region, thereby controlling an arrangement direction of the liquid crystal molecules 31. As a result, texture defects of the liquid crystal display may be reduced.

The first minute branch electrodes 193h are extended from the oblique sides of the first partial plate electrode 192h. The first minute branch electrodes 193h are filled in the remaining portions of the square region, and form an angle in a range from about 40° to about 50° with respect to the gate line 121 or the data line 171, and also form an angle in a range from about 67° to about 95° with respect to the oblique sides of the first partial plate electrode 192h.

In the exemplary embodiment of FIG. 1, the first sub-pixel electrode 191h includes a first minute branch connection 194h connecting the ends of the first minute branch electrodes 193h and the first partial plate electrode 192h in the longitudinal or horizontal direction. The first minute branch connection 194h overlaps the first sub-pixel electrode 191h and the underlying storage electrodes 135a and 135b, thereby forming a storage capacitance. However, according to another exemplary embodiment, the first minute branch connection 194h may be omitted, and the first minute branch electrodes 193h protrude to the outside.

The second sub-pixel electrode 191l includes the second partial plate electrode 192l positioned at the center of a longitudinally extending rectangular region and the second minute branch electrodes 193l extending from the second partial plate electrode 192l, and is connected to the wide end portion of the second drain electrode 175b by a second connection 197l extends from the rectangular region.

The second partial plate electrode 192l has a rhombus shape, a center thereof is positioned at a center of the rectangular region, and some vertices of the rhombus shape meet the boundary of the rectangular region. The second partial plate electrode 192l is disposed to surround the second step providing grooves 185l. The second partial plate electrode 192l includes four sides that are respectively in parallel with the hypotenuses of the second step providing grooves 185l. Accordingly, an angle between one side of the second partial plate electrode 192l and the gate line may be about 45° or less.

Referring again to FIG. 2, the second partial plate electrode 192l is disposed to cover the second step providing groove 185l of the passivation layer 180 and the second protrusion 182l of the cross type. As a result, the second partial plate electrode 192l has a step provided by the second step providing groove 185l of the passivation layer 180 and the second protrusion 182l of the cross type.

The second minute branch electrodes 193l are extended from the oblique sides of the second partial plate electrode 192l. The second minute branch electrodes 193l are filled in the remaining portions of the rectangular region, and form an angle in a range from about 40° to about 50° with respect to the gate line 121 or the data line 171, and also form an angle in a range from about 67° to about 95° with respect to the oblique sides of the second partial plate electrode 192l.

In the exemplary embodiment of FIG. 1, the second sub-pixel electrode 191l includes a second minute branch connection 194l connecting the ends of the second minute branch electrodes 193l and the second partial plate electrode 192l in the longitudinal or horizontal direction. The second minute branch connection 194l overlaps the second sub-pixel electrode 191l and the underlying storage electrodes 135b and 135c, thereby forming a storage capacitance. However, according to another exemplary embodiment, the second minute branch connection 194l may be omitted, and in this case, the second minute branch electrodes 193l protrude to the outside.

The first sub-pixel electrode 191h and the second sub-pixel electrode 191l are physically and electrically connected to the first drain electrode 175a and the second drain electrode 175b through the contact holes 184a and 184b, thereby receiving data voltages from the first drain electrode 175a and the second drain electrode 175b. A portion of the data voltage applied to the second drain electrode 175b is divided through the third source electrode 173c, so that a magnitude of the voltage applied to the second sub-pixel electrode 191l is smaller than the magnitude of the voltage applied to the first sub-pixel electrode 191h. Herein, an area of the second sub-pixel electrode 191l may range approximately from one times to two times larger than that of the first sub-pixel electrode 191h.

A storage electrode connecting member 139 connects the capacitor electrode 134 of the storage voltage line 131 with the third drain electrode 175c through the contact hole 184c. A storage voltage Vcst is applied to the capacitor electrode 134 of the storage voltage line 131, thereby applying the storage voltage Vcst to the third thin film transistor Qc through the third drain electrode 175c. As a result, the voltage applied to the second sub-pixel may be decreased.

In addition, a cover 199 covering the opening 189 of the passivation layer 180 may be formed on the opening 189. The cover 199 may be formed to block transmission of gas emitted from the color filter 230 to other elements. As shown in FIG. 1, one pixel may include a pair of covers 199. The pixel electrode 191 and the cover 199 may be made of a transparent conductive material such as ITO or IZO. According to another exemplary embodiment, the opening 189 and the cover 199 may be omitted.

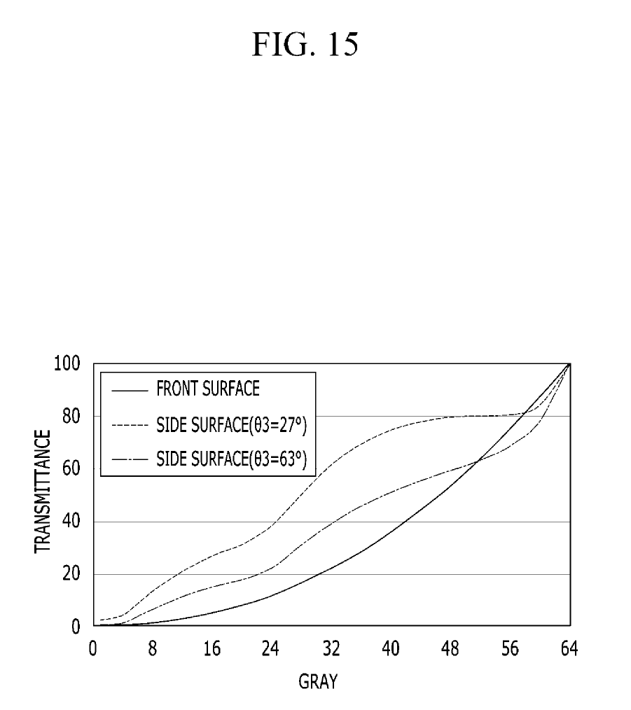

A lower alignment layer (not shown) is formed on the pixel electrodes 191. The lower alignment layer may be a vertical alignment layer, and may include a photo-reactive material. The photo-reactive material will be described later with reference to FIG. 15.

Next, the upper panel 200 will be described.

A light blocking member 220 may be formed on an insulation substrate 210. The light blocking member 220 may be referred to as black matrix, and may prevents light leakage. The light blocking member 220 may extend upwardly and downwardly along the gate line 121 and the step-down gate line 123 to cover a region where the first thin film transistor (Qh), the second thin film transistor (Ql), and the third thin film transistor (Qc) are positioned, and may extend along the data line 171 to cover the surroundings of the data line 171. A region that is not covered by the light blocking member 220 may display images by emitting light to the outside.

A planarization layer 250 may be formed to provide a planar lower surface below the light blocking member 220, and may be made out of an organic material.

A common electrode 270 made of a transparent conductive material may be formed below the planarization layer 250.

An upper alignment layer (not shown) may be formed below the common electrode 270. The upper alignment layer may be a vertical alignment layer, and may be an alignment layer photo-aligned with a photo-polymer material.

Polarizers (not shown) may be formed on the outer surface of the display panels 100 and 200. Herein, the polarization axes of the two polarizers may be crossed, and one polarization axis thereof may be parallel to the gate lines 121. However, the polarizer may be exclusively disposed on one outer surface of either one of the two display panels 100 and 200.

The first sub-pixel electrode 191h and the second sub-pixel electrode 191l having the data voltage applied thereto generate an electric field with the common electrode 270 of the upper electrode panel 200. In response to the generated electric field, the liquid crystal molecules 31 of the liquid crystal layer 3, which are aligned to be perpendicular to surfaces of two electrodes 191 and 270 in the absence of the electric field, are slanted in the direction parallel to the surface of the two electrodes 191 and 270. Accordingly, the luminance of the light transmitted through the liquid crystal layer 3 may differ depending on the slant degree of the liquid crystal molecules 31.

The liquid crystal display may further include a spacer to maintain a cell interval between the two display panels 100 and 200, and the spacer may be attached to the upper display panel 200 or the lower display panel 100.

The liquid crystal layer 3 interposed between the lower panel 100 and the upper panel 200 may include liquid crystal molecules 31 having negative dielectric anisotropy.

The liquid crystal layer 3 or the alignment layer (not shown) may further include a polymer that is polymerized by light, such as ultraviolet rays. The polymer included in the liquid crystal layer 3 provides the pretilt to the liquid crystal layer 3, and a method of providing the pretilt angle will be described in detail with reference to FIG. 15. However, the liquid crystal layer 3 may not include the polymer when the arrangement direction is sufficiently controlled without the polymer providing the pretilt angle.

As described above, in the exemplary embodiment of FIG. 1 and FIG. 2, the step provider is formed in the passivation layer 180 of the organic insulator, and includes the step providing grooves 185h and 185l and the cross-like protrusions 182h and 182l positioned between the step providing grooves 185h and 185l.

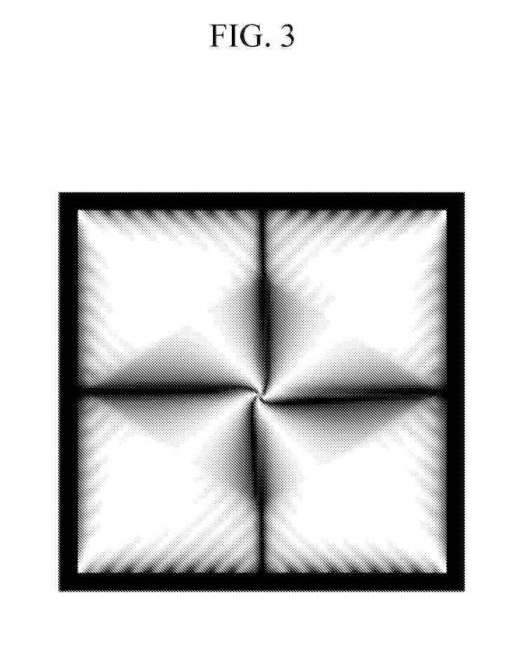

Hereinafter, a characteristic improving the texture of a liquid crystal display according to an exemplary embodiment of the present invention will be described with reference to FIG. 3.

FIG. 3 is a view illustrating the liquid crystal display according to an exemplary embodiment of the present invention. Specifically, the liquid crystal display of FIG. 3 has the angle θ1 between the first side and the hypotenuse of each of the step providing grooves set as about 35°, and as shown in FIG. 3, the texture is hardly generated.

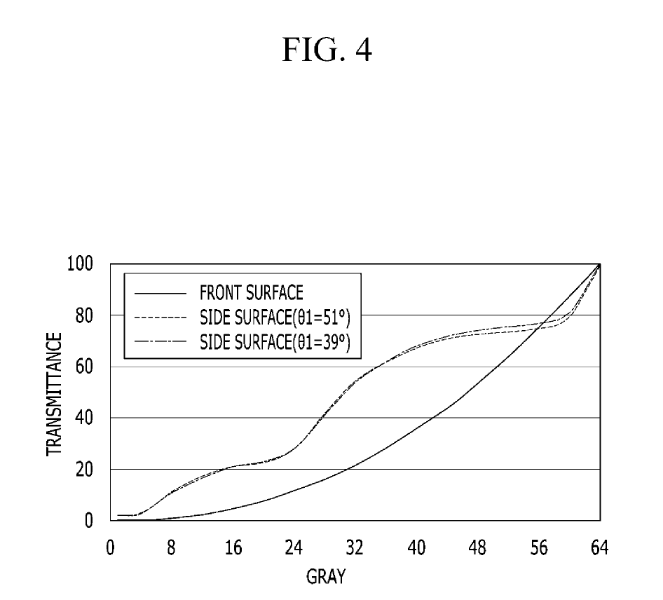

Hereinafter, a characteristic improving the side visibility of a liquid crystal display according to an exemplary embodiment of the present invention will be described with reference to FIG. 4.

FIG. 4 is a gray-transmittance graph illustrating a front surface and a side surface of a liquid crystal display according to an exemplary embodiment of the present invention. For comparison purposes, the graph of FIG. 4 illustrates the gray-transmittances when the angle θ1 between the first side and the hypotenuse of each of the step providing grooves is set as about 51° and about 39°.

The side visibility may also be improved when the gray-transmittance curve of the side surface is close to the gray-transmittance curve of the front surface.

When the angle θ1 between the first side and the hypotenuse is set as 39°, rather than 51°, the gray-transmittance curve of the side surface is closer to the gray-transmittance curve of the front surface. Accordingly, the side visibility can be improved as the angle θ1 between the first side and the hypotenuse of each of the step providing grooves becomes smaller.

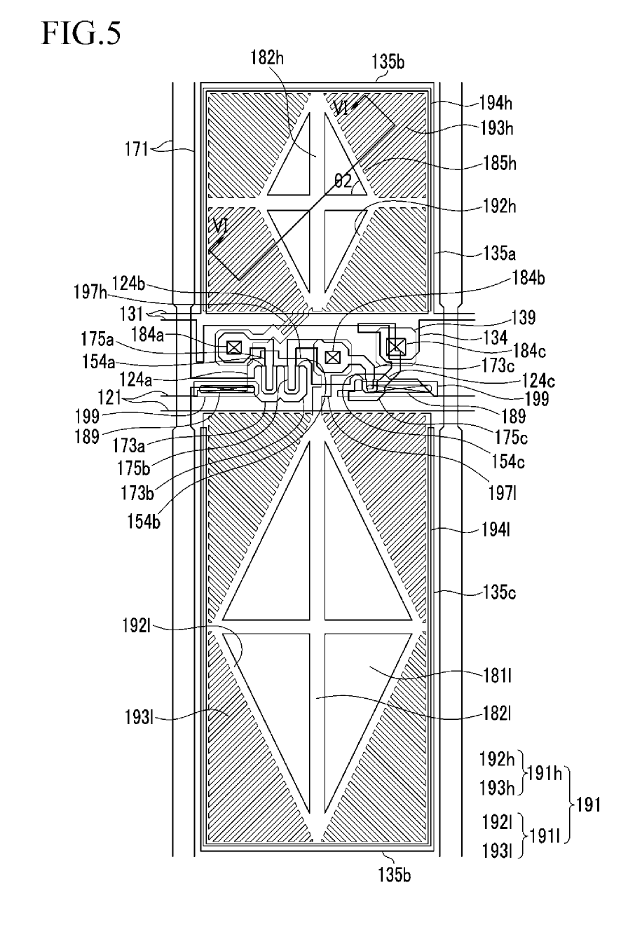

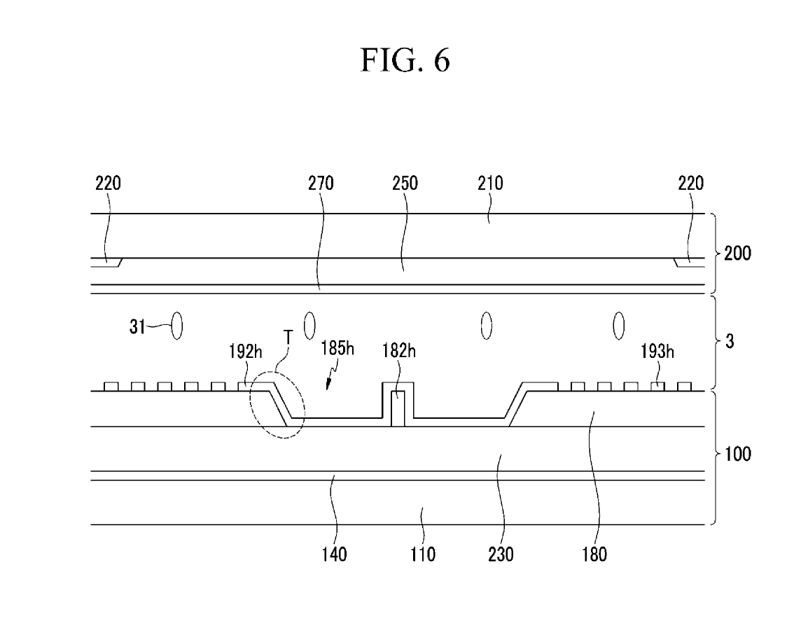

Next, a liquid crystal display according to an exemplary embodiment of the present invention will be described with reference to FIG. 5 and FIG. 6.

The liquid crystal display according to the exemplary embodiment of the present invention illustrated in FIG. 5 and FIG. 6 is substantially the similar to the liquid crystal display according to the exemplary embodiment illustrated in FIG. 1 and FIG. 2, and repeated description thereof is omitted. The present exemplary embodiment is different from the above exemplary embodiment in that sidewalls of the step providing grooves are inclined, which will be described in more detail.

FIG. 5 is a layout view of a liquid crystal display according to an exemplary embodiment of the present invention, and FIG. 6 is a cross-sectional view taken along the line VI-VI of FIG. 5. Since the cross-sectional view of the first sub-pixel electrode 191h as illustrated in FIG. 6 is substantially similar as the second sub-pixel electrode 191l, corresponding components of the second sub-pixel electrode 191l will also be illustrated in FIG. 6.

As in the above exemplary embodiment, a step provider is formed in the passivation layer 180, and includes step providing grooves 185h and 185l, and protrusions 182h and 182l.

A planar shape of the step providing grooves 185h and 185l is formed of right triangles each of which has a first side that is in parallel with a gate line, a second side that is in parallel with a data line, and a hypotenuse that connects the first side with the second side. In this case, an angle θ2 between the first side and the hypotenuse may range from about 45° to about 63°. For example, the angle θ2 between the first side and the hypotenuse may be about 63°. In the present exemplary embodiment, the liquid crystal controllability and the side visibility may be improved by adjusting the angle θ2 between the first side and the hypotenuse to be 45° or greater, rather than less than 45°.

Referring to a region T shown in FIG. 6, a sidewall of the step providing grooves 185h and 185l are inclined with respect to a bottom surface. In other words, the sidewalls of the step providing grooves 185h and 185l have a tapered structure. A sidewall corresponding to the hypotenuse of each right triangle in the planar shape of the step providing grooves 185h and 185l has the tapered structure.

In FIG. 6, the tapered structure is not applied to the cross-like protrusions 182h and 182l formed on the passivation layer 180 serving as an organic insulator. However, according to another exemplary embodiment, the tapered structure may be applied to the cross-like protrusions 182h and 182l.

A pixel electrode 191 including the first sub-pixel electrode 191h and the second sub-pixel electrode 191l is formed on the passivation layer 180.

The first sub-pixel electrode 191h includes a first partial plate electrode 192h and a plurality of first minute branch electrodes 193h extending from the first partial plate electrode 192h. The first partial plate electrode 192h is disposed to surround the first step providing grooves 185h. The first partial plate electrode 192h includes four sides that are respectively in parallel with the hypotenuses of the four first step providing grooves 185h. Accordingly, an angle between one side of the first partial plate electrode 192h and the gate line may range from about 45° to about 63°.

The first partial plate electrode 192h is disposed to cover the first step providing groove 185h of the passivation layer 180 and a first protrusion 182h of the cross type. As a result, the first partial plate electrode 192h has a step provided by the first step providing groove 185h of the passivation layer 180 and the first protrusion 182h of the cross type, and the inclination is formed at a portion corresponding to the sidewalls of the first step providing grooves 192h that are inclined.

The second sub-pixel electrode 191l includes a second partial plate electrode 192l and a plurality of second minute branch electrodes 193l extending from the second partial plate electrode 192l. The second partial plate electrode 192l is disposed to surround the second step providing grooves 185l. The second partial plate electrode 192l includes four sides that are respectively in parallel with the hypotenuses of the second step providing grooves 185l. Accordingly, an angle between one side of the second partial plate electrode 192l and the gate line may range from about 45° to about 63°.

The second partial plate electrode 192l is disposed to cover the second step providing groove 185l of the passivation layer 180 and a second protrusion 182l of the cross type. As a result, the second partial plate electrode 192l has a step provided by the second step providing groove 185l of the passivation layer 180 and the second protrusion 182l of the cross type, and the inclination is formed at a portion corresponding to the sidewalls of the second step providing grooves 192l that are inclined.

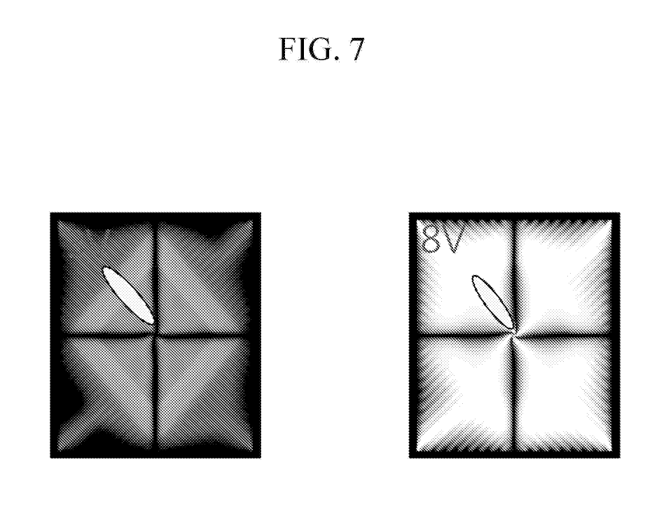

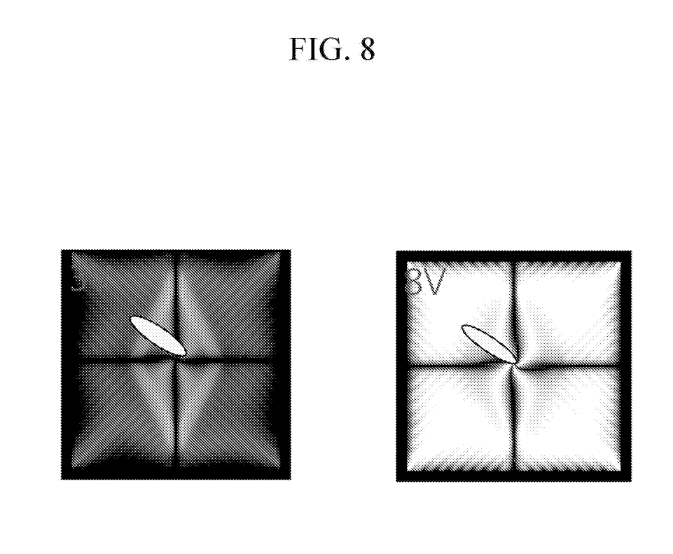

Hereinafter, a characteristic improving the texture of a liquid crystal display according to an exemplary embodiment of the present invention will be described with reference to FIG. 7 and FIG. 8.

FIG. 7 and FIG. 8 are views illustrating the liquid crystal display according to an exemplary embodiment of the present invention. Specifically, the liquid crystal display of FIG. 7 has the angle θ2 between the first side and the hypotenuse of each of the step providing grooves set as about 51°, and the liquid crystal display in FIG. 8 has the angle θ2 set as about 63°. As shown in FIG. 7 and FIG. 8, the texture is hardly generated.

In FIG. 7 and FIG. 8, liquid crystal molecules positioned on the partial plate electrodes are illustrated to have an ellipsoidal shape. In the case of the liquid crystal molecules positioned on the partial plate electrodes, an angle between the liquid crystal molecules and the first side may become smaller when the angle θ2 between the first side and the hypotenuse is set as about 63° rather than as about 51°. As a result, the liquid crystal molecules may become further inclined toward the horizontal direction, thereby further improving the side visibility.

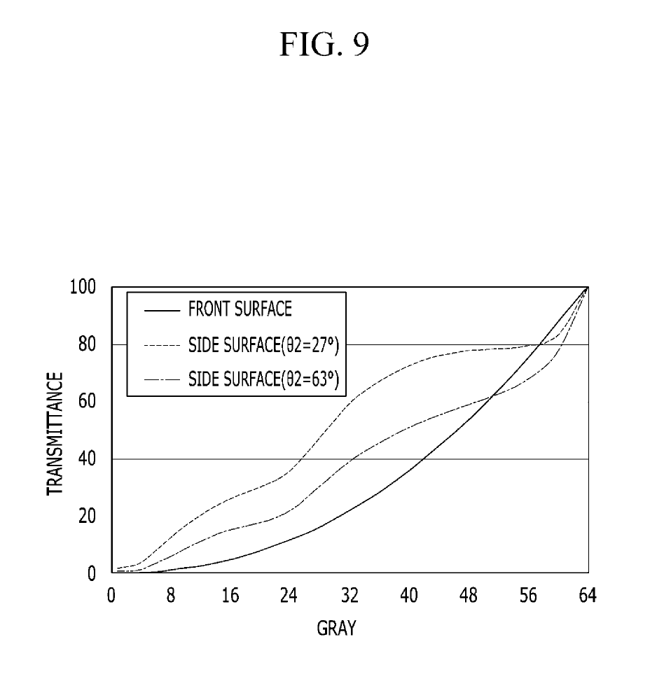

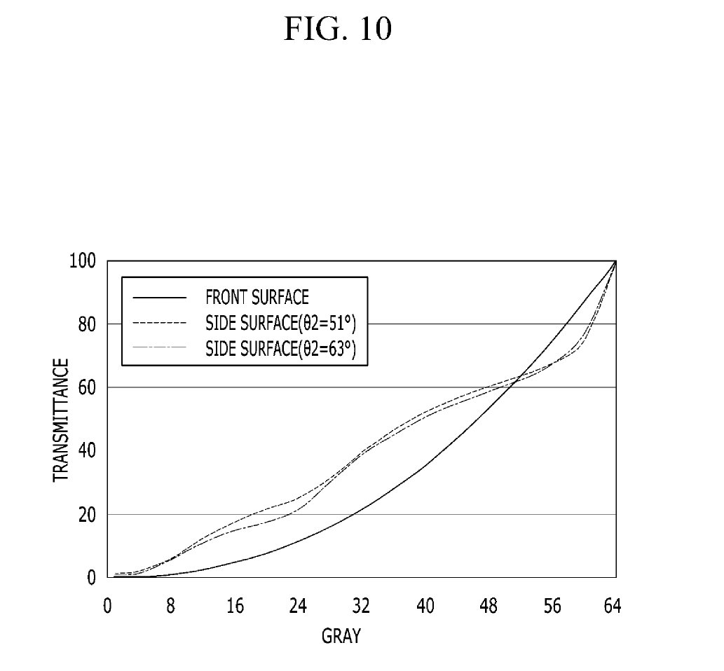

Hereinafter, a characteristic improving the side visibility of a liquid crystal display according to an exemplary embodiment of the present invention will be described with reference to FIG. 9 and FIG. 10.

FIG. 9 and FIG. 10 are gray-transmittance graphs illustrating a front surface and a side surface of a liquid crystal display according to an exemplary embodiment of the present invention. For comparison purposes, the graph of FIG. 9 illustrates the gray-transmittances when the angle θ2 between the first side and the hypotenuse of each of the step providing grooves is set as about 27° and about 63°. Similarly, the graph of FIG. 10 illustrates the gray-transmittances when the angle θ2 between the first side and the hypotenuse of each of the step providing grooves is set as about 51°, and about 63°.

As shown in FIG. 9, when the angle θ2 between the first side and the hypotenuse is set as 63° rather than 27°, the gray-transmittance curve of the side surface is closer to the gray-transmittance curve of the front surface. Accordingly, the side visibility may be improved as the angle θ2 between the first side and the hypotenuse of each of the step providing grooves becomes larger.

As shown in FIG. 10, when the angle θ2 between the first side and the hypotenuse is set as 63° rather than 51°, the gray-transmittance curve of the side surface is closer to the gray-transmittance curve of the front surface. Accordingly, the side visibility may be improved as the angle θ2 between the first side and the hypotenuse of each of the step providing grooves becomes larger.

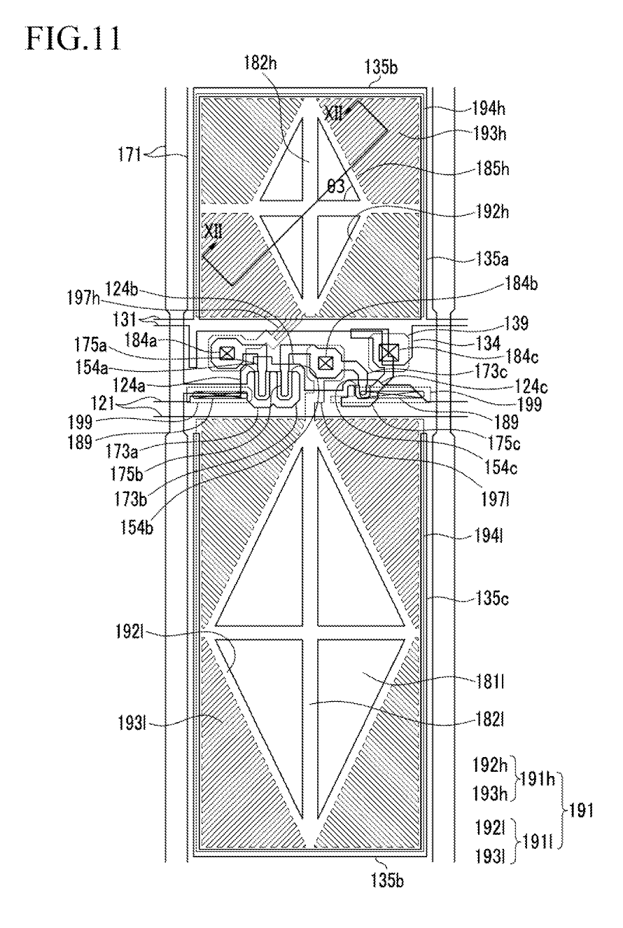

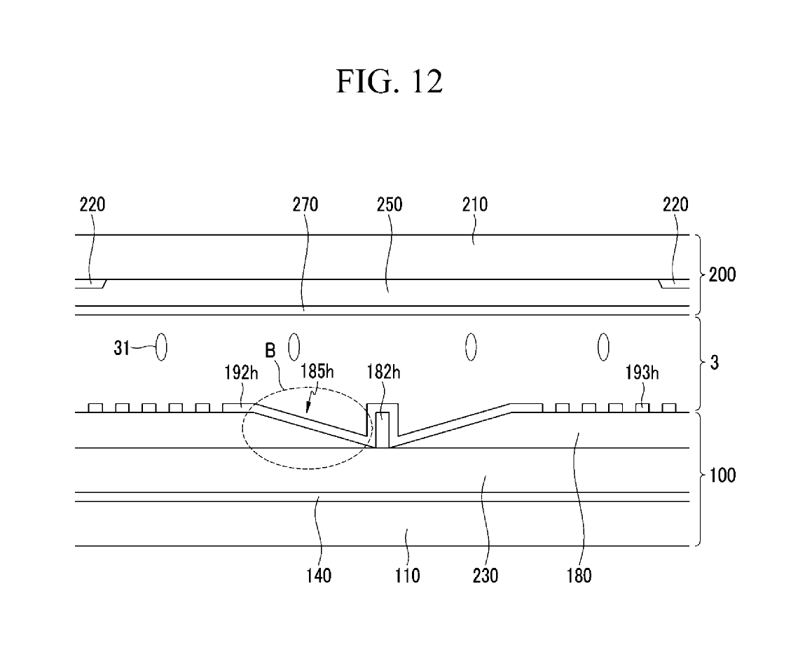

Next, a liquid crystal display according to an exemplary embodiment of the present invention will be described with reference to FIG. 11 and FIG. 12.

The liquid crystal display according to the exemplary embodiment of the present invention illustrated in FIG. 11 and FIG. 12 is substantially similar to the liquid crystal display according to the exemplary embodiment illustrated in FIG. 5 and FIG. 6, and repeated description thereof is omitted. The present exemplary embodiment is different from the above exemplary embodiment in that insides of the step providing grooves are generally inclined, which will be described in more detail.

FIG. 11 is a layout view of a liquid crystal display according to an exemplary embodiment of the present invention, and FIG. 12 is a cross-sectional view taken along the line XII-XII of FIG. 11. Since the cross-sectional view of the first sub-pixel electrode 191h as illustrated in FIG. 12 is substantially similar as the second sub-pixel electrode 191l, corresponding components of the second sub-pixel electrode 191l will also be illustrated in FIG. 12.

As in the above exemplary embodiment, a step provider may be formed in the passivation layer 180, and may include step providing grooves 185h and 185l, and protrusions 182h and 182l.

A planar shape of the step providing grooves 185h and 185l may be formed of right triangles each of which has a first side that is in parallel with a gate line, a second side that is in parallel with a data line, and a hypotenuse that connects the first side with the second side. In this case, an angle θ3 between the first side and the hypotenuse may range from about 45° to about 63°. For example, the angle θ3 between the first side and the hypotenuse may be about 63°. In the present exemplary embodiment, the liquid crystal controllability and the side visibility may be improved by adjusting the angle θ3 between the first side and the hypotenuse to be 45° or greater, rather than less than 45°.

Referring to a region B shown in FIG. 12, a sidewall of the step providing grooves 185h and 185l is inclined. That is, the bottom surface and the sidewall are integrally formed to be inclined with respect to each other with a predetermined slope. As a result, in the exemplary embodiment of FIG. 12, a tapered region may be formed to be wider than the tapered structure in the exemplary embodiment of FIG. 6, and thus the sidewall has a tapered structure that is tapered throughout the region B as shown in FIG. 12. In this case, a sidewall corresponding to the hypotenuse of right triangle in the planar shape of the step providing grooves 185h and 185l has the tapered structure. Specifically, in the planar surface of the step providing grooves 185h and 185l, the tapered structure may be inclined from the hypotenuse of each right triangle towards the first side and the second side of the right triangle.

A pixel electrode 191 including the first sub-pixel electrode 191h and the second sub-pixel electrode 191l may be formed on the passivation layer 180.

The first sub-pixel electrode 191h includes a first partial plate electrode 192h and a plurality of first minute branch electrodes 193h extending from the first partial plate electrode 192h. The first partial plate electrode 192h is disposed to surround the first step providing grooves 185h. The first partial plate electrode 192h includes four sides that are respectively in parallel with the hypotenuses of the four first step providing grooves 185h. Accordingly, an angle between one side of the first partial plate electrode 192h and the gate line may range from about 45° to about 63°.

The first partial plate electrode 192h may be disposed to cover the first step providing groove 185h of the passivation layer 180 and a first protrusion 182h of the cross type. As a result, the first partial plate electrode 192h may have a step provided by the first step providing groove 185h of the passivation layer 180 and the first protrusion 182h of the cross type, and the first partial plate electrode 192h is also inclined at a portion of the first step providing grooves 192h that is inclined.

The second sub-pixel electrode 191l includes a second partial plate electrode 192l and a plurality of second minute branch electrodes 193l extending from the second partial plate electrode 192l. The second partial plate electrode 192l is disposed to surround the second step providing grooves 185l. The second partial plate electrode 192l includes four sides that are respectively in parallel with the hypotenuses of the second step providing grooves 185l. Accordingly, an angle between one side of the second partial plate electrode 192l and the gate line may range from about 45° to about 63°.

The second partial plate electrode 192l may be disposed to cover the second step providing groove 185l of the passivation layer 180 and a second protrusion 182l of the cross type. As a result, the second partial plate electrode 192l may have a step provided by the second step providing groove 185l of the passivation layer 180 and the second protrusion 182l of the cross type, and the second partial plate electrode 192l is also inclined at a portion of the second step providing grooves 192l that is inclined.

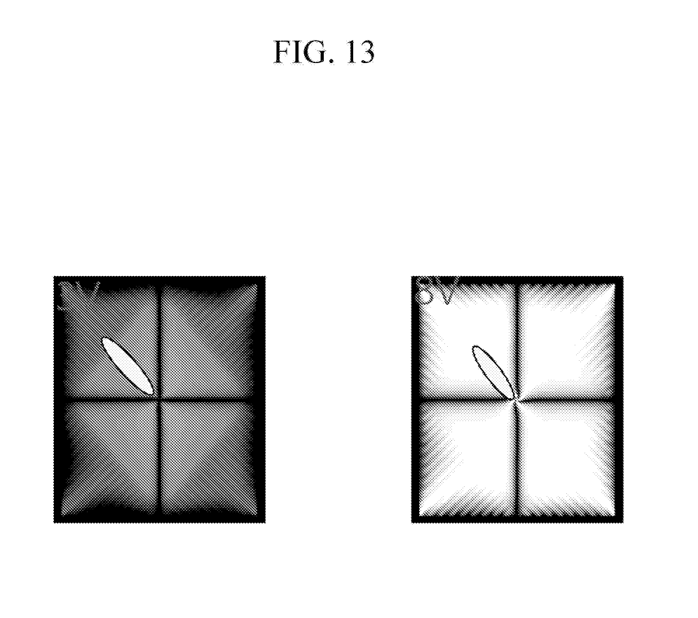

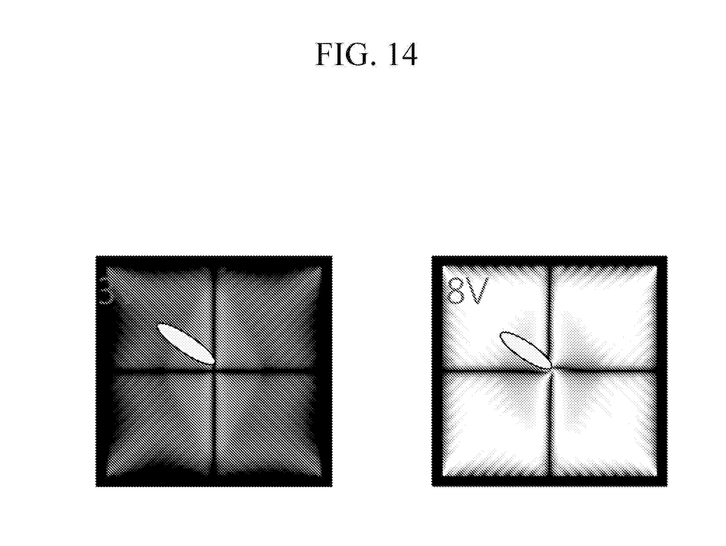

Hereinafter, a characteristic improving the texture of a liquid crystal display according to an exemplary embodiment of the present invention will be described with reference to FIG. 13 and FIG. 14.

FIG. 13 and FIG. 14 are views illustrating the liquid crystal display according to an exemplary embodiment of the present invention. Specifically, the liquid crystal display in FIG. 13 has the angle θ3 between the first side and the hypotenuse of each of the step providing grooves set as about 51°, and the liquid crystal display in FIG. 14 has the angle set as about 63°. As shown in FIG. 13 and FIG. 14, the texture is hardly generated.

In FIG. 13 and FIG. 14, liquid crystal molecules positioned on the partial plate electrodes are illustrated to have an ellipsoidal shape. In the case of the liquid crystal molecules positioned on the partial plate electrodes, an angle between the liquid crystal molecules and the first side may become smaller when the angle θ3 between the first side and the hypotenuse is set as about 63° rather than as about 51°. As a result, the liquid crystal molecules may become further inclined toward the horizontal direction, thereby further improving the side visibility.

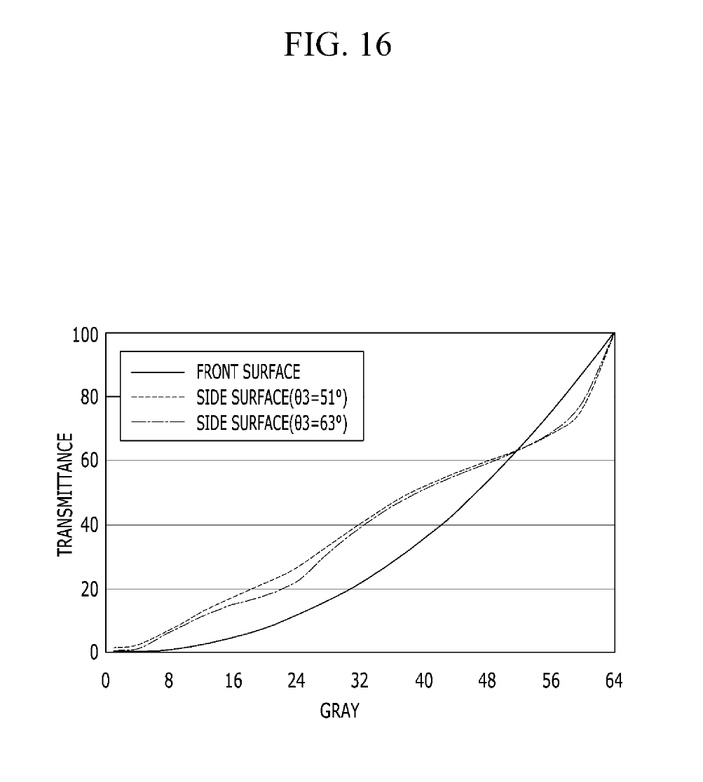

Hereinafter, a characteristic improving the side visibility of a liquid crystal display according to an exemplary embodiment of the present invention will be described with reference to FIG. 15 and FIG. 16.

FIG. 15 and FIG. 16 are gray-transmittance graphs illustrating a front surface and a side surface of a liquid crystal display according to an exemplary embodiment of the present invention. For comparison purposes, the graph of FIG. 15 illustrates the gray-transmittances when the angle θ3 between the first side and the hypotenuse of each of the step providing grooves is set as about 27° and about 63°. Similarly, the graph of FIG. 16 illustrates the gray-transmittances when the angle θ3 between the first side and the hypotenuse of each of the step providing grooves is set as about 51° and about 63°.

As shown in FIG. 15, when the angle θ3 between the first side and the hypotenuse is set as 63° rather than 27°, the gray-transmittance curve of the side surface is closer to the gray-transmittance curve of the front surface. Accordingly, the side visibility may be improved as the angle θ3 between the first side and the hypotenuse of each of the step providing grooves becomes larger.

As shown in FIG. 16, when the angle θ3 between the first side and the hypotenuse is set as 63° rather than 51°, the gray-transmittance curve of the side surface is closer to the gray-transmittance curve of the front surface. Accordingly, the side visibility may be improved as the angle θ3 between the first side and the hypotenuse of each of the step providing grooves becomes larger.

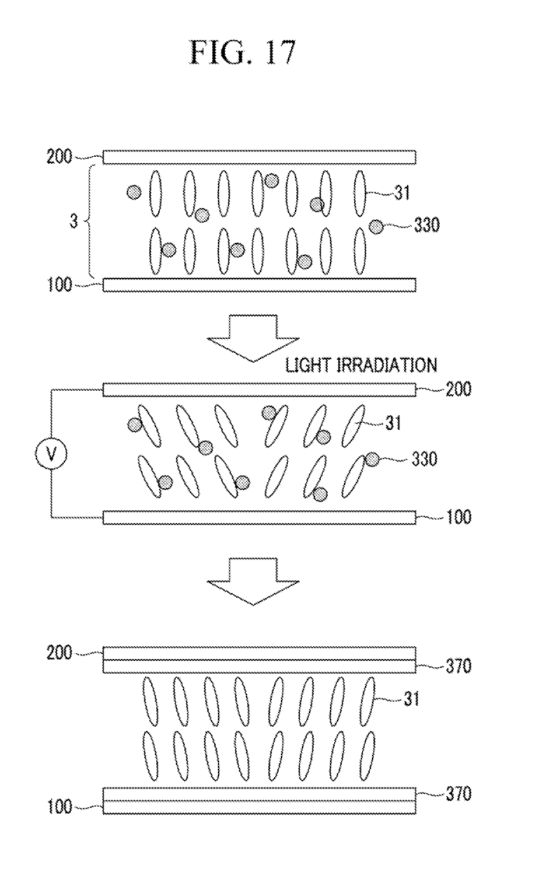

As described above, at least one of the liquid crystal layer 3 and the alignment layer may include a photo-reactive material, more specifically, a reactive mesogen. Next, a method of initially aligning liquid crystal molecules 31, thereby providing a pretilt, by using the photoreactive material will be described with reference to FIG. 17.

FIG. 17 shows a process for providing a pretilt to liquid crystal molecules by using prepolymers that are polymerized by light, such as ultraviolet rays.

Prepolymers 330 such as a monomer that is polymerized by light, such as ultraviolet rays, are injected along with a liquid crystal material 31 between the two display panels 100 and 200. The prepolymer 330 may be a reactive mesogen that is polymerized by light, such as ultraviolet rays.

Next, through various methods, voltages of different magnitudes are applied to the first sub-pixel electrode 191h and the second sub-pixel electrode 191l, and the common voltage is applied to the common electrode 270 of the upper display panel 200 to generate the electric field to the liquid crystal layer 3 between the two display panels 100 and 200. The electric field causes the first minute branch electrodes 193h of the first sub-pixel electrode 191h and the common electrode 270 to generate a fringe field. In response to the fringe field, the liquid crystal molecules 31 of the liquid crystal layer 3 are tilted in a direction parallel to the extending direction of the corresponding first minute branch electrodes 193h of the first sub-pixel electrode 191h. As such, the liquid crystal molecules 31 such, the liquid crystal layer 3 may be tilted in four directions respective to the first minute branch electrodes 193h.

Similarly, the liquid crystal molecules 31 of the liquid crystal layer 3 are tilted in a direction parallel to the extending direction of the corresponding second minute branch electrodes 193l of the second sub-pixel electrode 191l by a fringe field generated from the second minute branch electrodes 193l of the second sub-pixel electrode 191l and the common electrode 270. As such, the liquid crystal molecules 31 of the liquid crystal layer 3 may be tilted in four directions respective to the second minute branch electrodes 193l. Since different voltages are applied to the first sub-pixel electrode 191h and the second sub-pixel electrode 191l, the inclination angle of the liquid crystal molecules 31 corresponding to the first sub-pixel electrode 191h and the inclination angle of the liquid crystal molecule 31 corresponding to the second sub-pixel electrode 191l of to the first substrate 110 may become different from each other.

After the electric field to the liquid crystal layer 3 is generated, when light, such as ultraviolet rays, is irradiated thereto, the prepolymers 330 are polymerized to form a polymer 370. The polymer 370 may be formed while contacting the display panels 100 and 200. As illustrated above, the polymer 370 sets the alignment direction of the liquid crystal molecules 31 to provide the pretilt. Accordingly, the liquid crystal molecules 31 may be arranged with the pretilts of four different directions even when no voltage is applied to the electric field generating electrodes 191 and 270.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A liquid crystal display, comprising:
a substrate;
an insulating layer disposed on the substrate;
step providing grooves disposed on the insulating layer; and
a pixel electrode disposed on the insulating layer, the pixel electrode comprising a partial plate electrode and minute branch electrodes extending from the partial plate electrode,
wherein:
a sidewall of each step providing groove is perpendicular to a bottom surface thereof;
a planar shape of the step providing grooves comprises right triangles each having a first side, a second side, and a hypotenuse that connects the first side and the second side; and
an angle between the first side and the hypotenuse is less than or equal to 45°.

2. The liquid crystal display of claim 1, wherein:
the planar shape of the step providing grooves comprises four right triangles;
the triangles are disposed such that the first sides thereof are adjacent to each other and the second sides thereof are adjacent to each other; and
the first sides are disposed in a horizontal direction, and the second sides are disposed in a vertical direction.

3. The liquid crystal display of claim 2, wherein:
the partial plate electrode has a rhombus shape; and
four sides of the partial plate electrode are respectively parallel to the hypotenuses of the four right triangles.

4. The liquid crystal display of claim 3, further comprising
a gate line disposed on the substrate and extending in a direction that is parallel to the first sides of the step providing grooves,
wherein an angle between one side of the partial plate electrode and the gate line is less than or equal to 45°.

5. The liquid crystal display of claim 1, wherein:
the partial plate electrode has a rhombus shape; and
four sides of the partial plate electrode are respectively parallel to the hypotenuses of the four right triangles.

6. The liquid crystal display of claim 5, further comprising
a gate line disposed on the substrate and extending in a direction that is parallel to the first sides of the step providing grooves,
wherein an angle between one side of the partial plate electrode and the gate line is less than or equal to 45°.

7. The liquid crystal display of claim 1, further comprising
a gate line disposed on the substrate and extending in a direction that is parallel to the first sides of the step providing grooves,
wherein an angle between one side of the partial plate electrode and the gate line is less than or equal to 45°.

8. A liquid crystal display, comprising:
a substrate;
an insulating layer disposed on the substrate;
step providing grooves disposed on the insulating layer; and
a pixel electrode disposed on the insulating layer, the pixel electrode comprising a partial plate electrode and minute branch electrodes extending from the partial plate electrode,
wherein:
a sidewall of each of the step providing grooves is inclined;
a planar shape of the step providing grooves comprises right triangles each having a first side, a second side, and a hypotenuse that connects the first side and the second side; and
an angle between the first side and the hypotenuse is in a range from 45° to 63°.

9. The liquid crystal display of claim 8, wherein the sidewall of each of the step providing grooves is inclined with respect to a bottom surface thereof.

10. The liquid crystal display of claim 9, wherein the partial plate electrode disposed on the inclined sidewall of each of the step providing grooves is inclined.

11. The liquid crystal display of claim 8, wherein the sidewall of each of the step providing grooves is integrally formed to be inclined with respect to a bottom surface thereof.

12. The liquid crystal display of claim 11, wherein the partial plate electrode disposed on the inclined sidewall of each of the step providing grooves is inclined.

13. The liquid crystal display of claim 8, wherein:
the planar shape of the step providing grooves comprises four right triangles;
the triangles are disposed such that the first sides thereof are adjacent to each other and the second sides thereof are adjacent to each other; and
the first sides are disposed in a horizontal direction, and the second sides are disposed in a vertical direction.

14. The liquid crystal display of claim 13, wherein:
the partial plate electrode has a rhombus shape; and
four sides of the partial plate electrode are respectively parallel to the hypotenuses of the four right triangles.

15. The liquid crystal display of claim 14, further comprising
a gate line disposed on the substrate and extending in a direction that is parallel to the first sides of the step providing grooves,
wherein an angle between one side of the partial plate electrode and the gate line is in a range from 45° to 63°.

16. The liquid crystal display of claim 8, wherein:
the partial plate electrode has a rhombus shape; and
four sides of the partial plate electrode are respectively parallel to the hypotenuses of the four right triangles.

17. The liquid crystal display of claim 16, further comprising
a gate line disposed on the substrate and extending in a direction that is parallel to the first sides of the step providing grooves,
wherein an angle between one side of the partial plate electrode and the gate line is in a range from 45° to 63°.

18. The liquid crystal display of claim 8, further comprising
a gate line disposed on the substrate and extending in a direction that is parallel to the first sides of the step providing grooves,
wherein an angle between one side of the partial plate electrode and the gate line is in a range from 45° to 63°.
